(19) United States
(12) Patent Application Publication
(10) Pub. No.: US 2024/0131776 A1
(43) Pub. Date: Apr. 25, 2024

(54) FORMING MOLD

(71) Applicant: DAEHAN SOLUTION CO., LTD, Incheon (KR)

(72) Inventors: Choong Ho KWON, Seoul (KR); Deok Man LEE, Incheon (KR)

(73) Assignee: DAEHAN SOLUTION CO., LTD, Incheon (KR)

(21) Appl. No.: 18/380,924

(22) Filed: Oct. 16, 2023

(30) Foreign Application Priority Data
Oct. 19, 2022 (KR) 10-2022-0135326

(51) Int. Cl. B29C 51/36; B29C 51/14

(52) U.S. Cl. CPC B29C 51/36; B29C 51/145; B29L 2031/3011

(57) ABSTRACT

In the present invention, a laser pointer is mounted on an upper mold and formed to mark a position of an auxiliary raw material disposed on a raw material disposed on a lower mold so that everyone can easily accurately arrange the auxiliary raw material at a predetermined position and molds the auxiliary raw material to improve a molding efficiency. In particular, in the present invention, the laser pointer is formed to mark vertex positions of the auxiliary raw material so that an operator can arrange vertexes of the auxiliary raw material at the predetermined position to quickly arrange the auxiliary raw material at the predetermined position and accurately mold the auxiliary raw material. In this case, in the present invention, at least two laser points are mounted along an edge of the upper mold to mark vertices of the auxiliary raw material so that the auxiliary raw material can be more quickly accurately disposed at the predetermined position and integrally molded.

### CROSS-REFERENCE TO RELATED APPLICATION

This application claims priority to and the benefit of Korean Patent Application No. 10-2022-0135326, filed on Oct. 20, 2022, the disclosure of which is incorporated herein by reference in its entirety.

### BACKGROUND

### 1. Field of the Invention

The present invention relates to a forming mold, and more specifically, to a forming mold in which a laser pointer is mounted on an upper mold and a mounting position of an auxiliary raw material is marked on a raw material using the laser pointer when the auxiliary raw material is disposed on and integrally molded with the raw material, and thus the auxiliary raw material is accurately disposed at a predetermined position so that work is quickly performed without the occurrence of defects. In this case, at least two laser points are formed on an edge of the upper mold to mark vertex positions of the auxiliary raw material to accurately mark the position at which the auxiliary raw material is disposed.

### 2. Discussion of Related Art

In general, forming molds are frequently used when products such as vehicle headliners or dash insulations having complex shapes are formed or when raw materials having different properties are stacked in multi-layer structures and integrally formed by applying heat and pressure. Such forming molds are manufactured in various shapes and used as illustrated in Patent Document 1 to Patent Document 3 below.

(Patent Document 1) Korean Patent Registration No. 10-2436971

The invention relates to a vacuum-thermoforming method for car interior components using fabric, and a vacuum-thermoforming mold thereof. In the vacuum-thermoforming method for car interior components using fabric, an upper mold including an electroforming mold in which a plurality of decompression vacuum holes which have diameters of 0.2 to 0.5 mm and are formed to be spaced at intervals of 3 to 10 mm or formed randomly and on which an embossing surface process is not performed, a press mold which supports the electroforming mold, and a plurality of metal ribs positioned between the electroforming mold and the press mold is used, a preheated fabric skin is positioned between the upper mold and a lower mold, and the upper mold and the lower mold are shape-coupled in order to inject hot air or overheated water vapor from the upper mold at a pressure of 1 to 3 kg/cm². According to the structure, when a fabric having an elongation of about 160% and the fabric skin formed as a polypropylene (PP) foam layer having an elongation of about 300% are attached to a substrate, there is no risk of defects such as a molding defect at a deep draw portion, overlapping of the fabric skin at a corner portion of a product, generation of a wave, and a burst, and thus the car interior components can be effectively economically manufactured. In addition, the car interior components using the fabric manufactured as described above have various unique and beautiful patterns inherent in the fabric, and a surface of the fabric has antifouling, wear-resistant, and water-resistant properties to have high ease of use and a long lifetime.

(Patent Document 2) Korean Patent Registration No. 10-2422416

A hot forming mold includes: a molding plate having a molding surface for forming a hot press molding product and a cooling surface formed on a surface opposite to the molding surface formed in a shape corresponding to the molding surface; a rib formed to extend from the cooling surface in a lattice shape to support the molding plate while forming a plurality of core grooves at a side in the cooling surface of the molding plate; a connecting passage which is formed to pass through the rib and allows the plurality of core grooves to communicate with each other; and a core which is inserted into the core grooves and has a surface in which and a plurality of cooling grooves communicating with the connection passage are engraved and in which inner surfaces of the core grooves and the cooling grooves form a plurality of cooling passages having a cross-section in a closed curve shape, wherein the plurality of the cooling passages are formed to have different cross-sectional areas according to positions, and the cooling passages are installed to communicate with the connection passage.

(Patent Document 3) Korean Patent Registration No. 10-2145551

The invention relates to a direct water spray cooling mold for hot stamping which is capable of manufacturing ultra-high-strength components by rapidly cooling a molding area of a material using a direct water spray cooling method immediately after molding a high-temperature material and includes a lower mold in which a punch part which presses and molds a first portion of a material and a flange part which holds a lower surface of a second portion of the material, an upper mold in which a molding part is formed, wherein the molding part holds an upper surface of the second portion of the material and accommodates the first portion of the material molded by the punch part and the punch part, and a direct water spray cooling device which allows cooling water to flow through at least one between the first portion of the material and the punch part and between the second portion and the flange part so that the material is rapidly cooled through a direct water spray cooling method in which the cooling water comes into direct contact with the material.

As illustrated in FIGS. 1 to 3, among these forming molds, a raw material may be disposed on a lower mold, and an auxiliary raw material may be disposed on and integrally molded with the raw material to form a molded product for partial rigidity reinforcement or heat reflection, and the like. FIG. 1 shows a state in which the lower mold and upper mold face each other, FIG. 2 shows a state in which the auxiliary raw material is disposed on the raw material disposed on the lower mold, and FIG. 3 shows the molded product formed using such a forming mold.

### RELATED ART

### Patent Document

(Patent Document 1) Korean Patent Registration No. 10-2436971 (Registration Date: Aug. 23, 2022)
(Patent Document 2) Korean Patent Registration No. 10-2422416 (Registration Date: Jul. 14, 2022)
(Patent Document 3) Korean Patent Registration No. 10-2145551 (Registration Date: Aug. 11, 2020)

### SUMMARY OF THE INVENTION

However, when an auxiliary raw material disposed on a raw material is integrally molded with the raw material using the conventional forming mold, the following problems occur as described with reference to FIGS. 4A and 4B.

(1) An auxiliary raw material (31) is disposed on a raw material (30) disposed on a lower mold 10, and then an upper mold (20) is shape-coupled to the lower mold (10) to form a molded product. In this case, since an area of the auxiliary raw material (31) is relatively smaller than an area of the raw material, the auxiliary raw material (31) should be disposed at a predetermined position.

(2) That is, the auxiliary raw material (31) is disposed to partially overlap the area of the raw material (30) so that the auxiliary raw material (31) partially covers a surface of a molded product or is integrally formed with the molded product to achieve predetermined objectives of partially reinforcing rigidity, blocking heat transfer, and the like.

(3) In this case, when the auxiliary raw material (31) is not disposed at the predetermined position on the raw material (30) disposed on the lower mold (10), not only a desired function may not be obtained, but a molding defect may also occur.

(4) In addition, since an operation of arranging the auxiliary raw material (31) on the raw material 30 is performed manually, not only it is difficult to arrange the auxiliary raw material (31) at the predetermined position, but it also takes a long time to accurately arrange the auxiliary raw material (31) at the predetermined position. Accordingly, a time for forming the molded product increases, and as a result, productivity is lowered.

(5) In addition, there is a risk of accidents occurring when a position is adjusted to arrange the auxiliary raw material (31) at the predetermined position.

The present invention is directed to providing a forming mold in which a laser pointer is mounted on an upper mold and formed to mark a position of an auxiliary raw material disposed on a raw material disposed on a lower mold so that everyone easily accurately arranges the auxiliary raw material at a predetermined position and molds the auxiliary raw material to improve a molding efficiency.

In particular, the present invention is also directed to providing the forming mold in which the laser pointer is formed to mark vertex positions of the auxiliary raw material so that an operator arranges vertexes of the auxiliary raw material at the predetermined positions to quickly arrange the auxiliary raw material at the predetermined position and accurately mold the auxiliary raw material.

In this case, the present invention is also directed to providing the forming mold in which at least two laser points are mounted along an edge of the upper mold to mark vertices of the auxiliary raw material so that the auxiliary raw material is more quickly accurately disposed at the predetermined position and integrally molded.

According to an aspect of the present invention, there is provided a forming mold including a lower mold (100) on which a raw material (110) to be molded in a predetermined shape is disposed and an upper mold (200) installed to face the lower mold (100) and shape-coupled to and shape-separated from the lower mold (100), wherein at least one laser pointer (210) is mounted on the upper mold (200), and the laser pointer (210) marks a position of an auxiliary raw material (111) when the auxiliary raw material (111) is disposed on and integrally molded with the raw material (110).

The laser pointer (210) may be mounted to mark at least two vertices of the auxiliary raw material (111).

In addition, the laser pointer (210) may be provided as at least two laser pointers (210) installed along an edge of the upper mold (200) and mark vertices of the auxiliary raw material (111).

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an image of a state in which a mold, on which aluminum glass cloth (ALGC) is disposed and integrally molded, is shape-separated, wherein the ALGC is an auxiliary raw material;

FIG. 2 is an image of a state in which a raw material (fabric) shown in black is disposed on a lower mold and the auxiliary raw material (ALGC) shown in silver is disposed on the raw material (fabric);

FIG. 3 is an image of a molded product integrally molded in a state in which the ALGC is disposed on the fabric;

FIGS. 4A and 4B are a set of views illustrating a structure of the conventional forming mold on which an auxiliary raw material is disposed on and integrally molded with a raw material, wherein FIG. 4A is a side view, and FIG. 4B is an enlarged view illustrating a portion on which the auxiliary raw material is disposed;

FIGS. 5A and 5B are is a set of views illustrating a stricture of a forming mold on which an auxiliary raw material is disposed on and integrally molded with a raw material according to the present invention, wherein FIG. 5A is a side view, and FIG. 5B is an enlarged view illustrating a portion on which the auxiliary raw material is disposed;

FIG. 6 is a bottom view illustrating a mounting position of a laser pointer on an upper mold constituting the forming mold according to the present invention; and

FIG. 7 is a bottom view illustrating a modified example of the mounting position of the laser pointer on the upper mold constituting the forming mold according to the present invention.

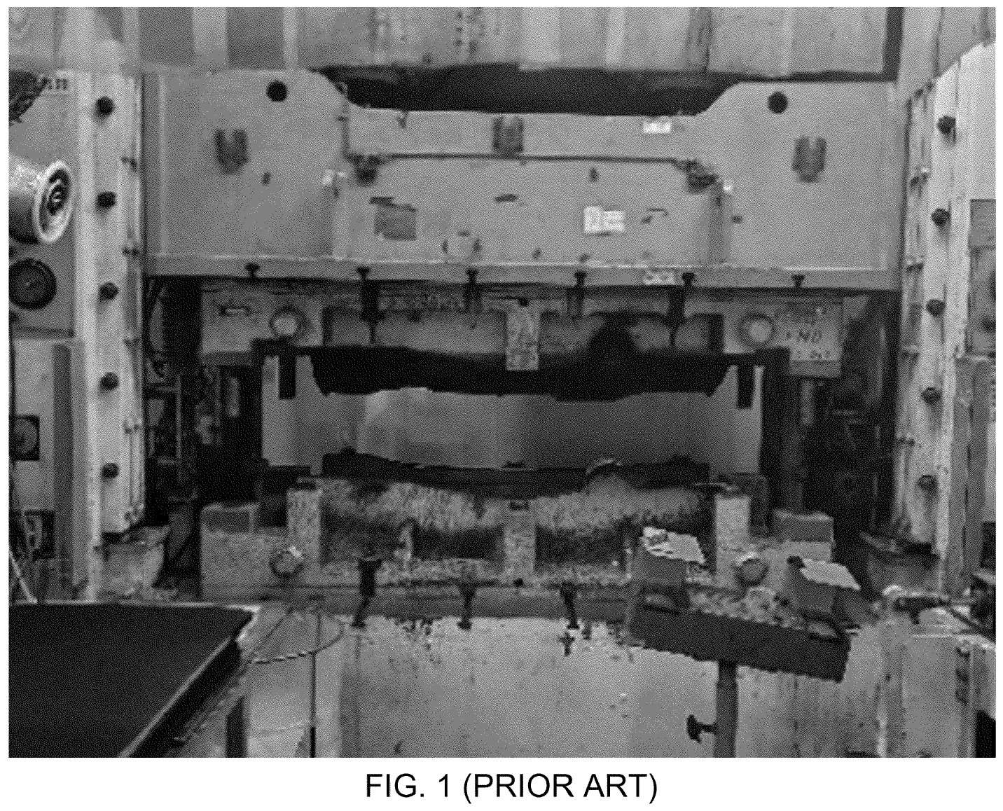

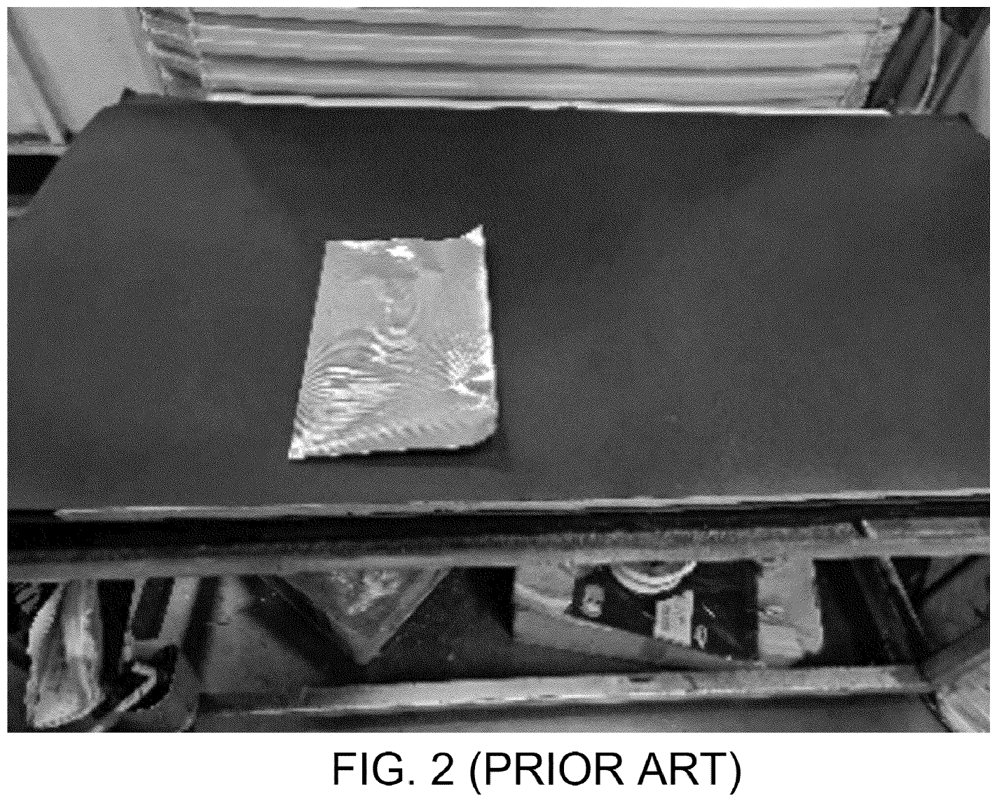

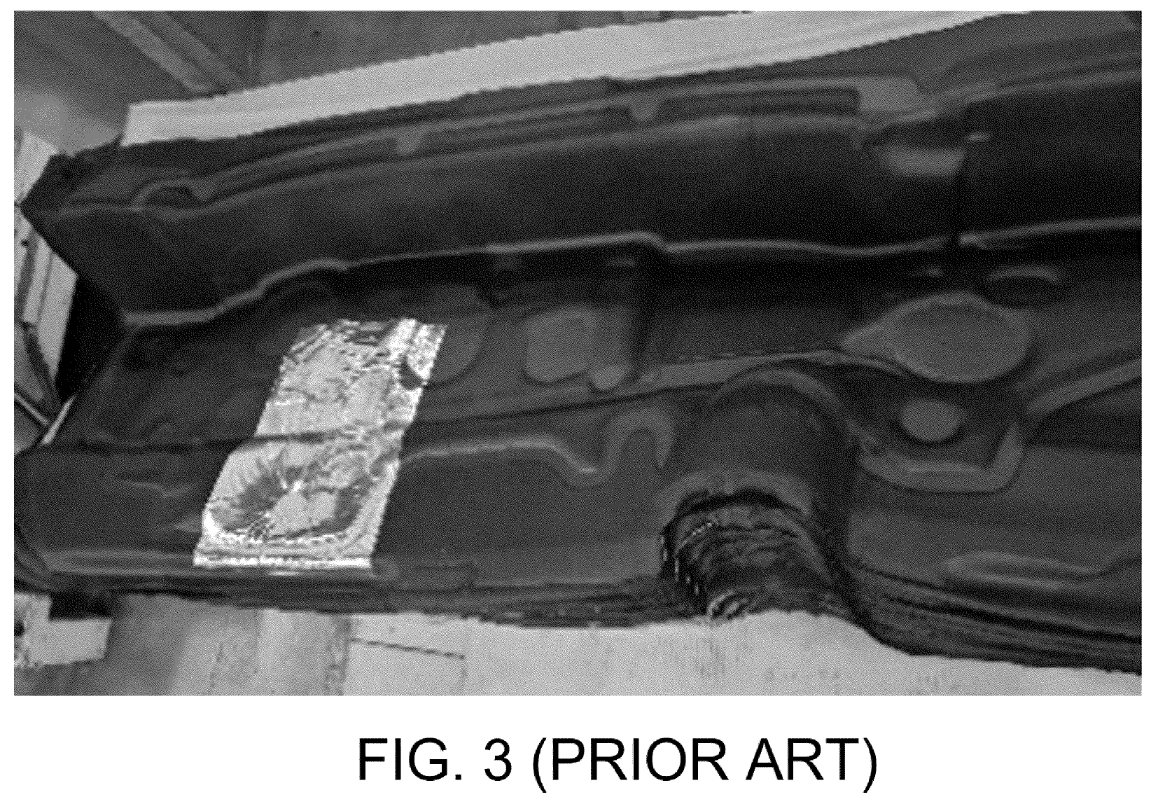

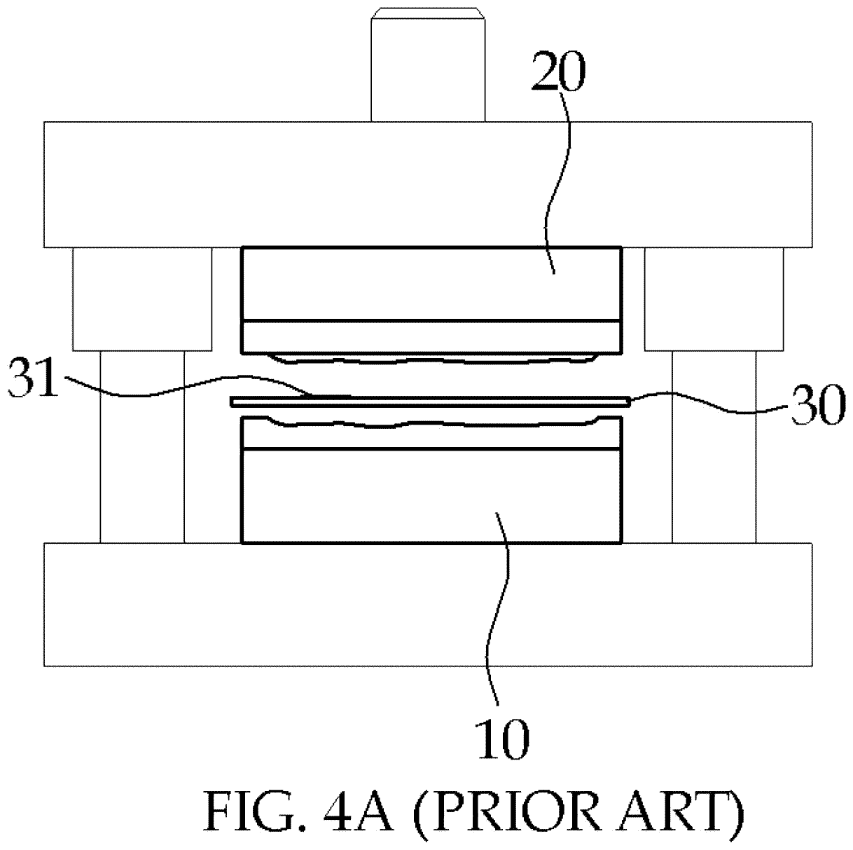

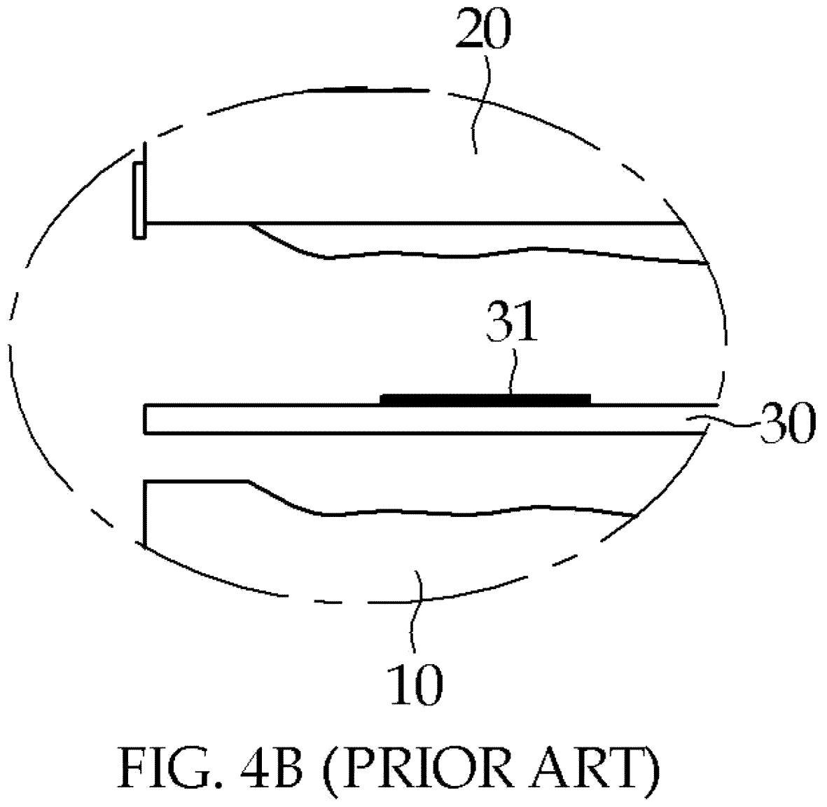

### DETAILED DESCRIPTION OF EXEMPLARY EMBODIMENTS

Hereinafter, exemplary embodiments of the present invention will be described in more detail with reference to the accompanying drawings. Moreover, terms and words used in the present specification and claims should not be interpreted as being limited to commonly used meanings or meanings in dictionaries and should be interpreted as having meanings and concepts which are consistent with the technological scope of the invention based on the principle that the inventors have appropriately defined concepts of terms in order to describe the invention in the best way.

Therefore, since the embodiments described in this specification and components illustrated in the drawings are only exemplary embodiments and do not represent the overall technological scope of the invention, it should be understood that there may be various equivalents or modifications substituting the exemplary embodiments at the time of filing of this application.

[Structure of Forming Mold]

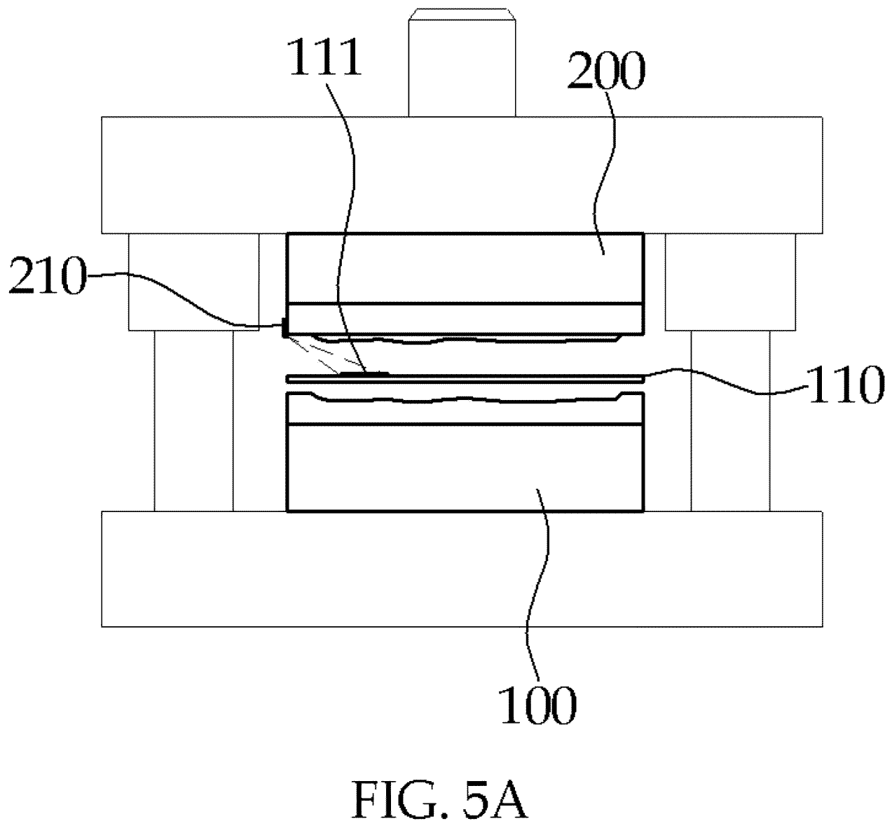

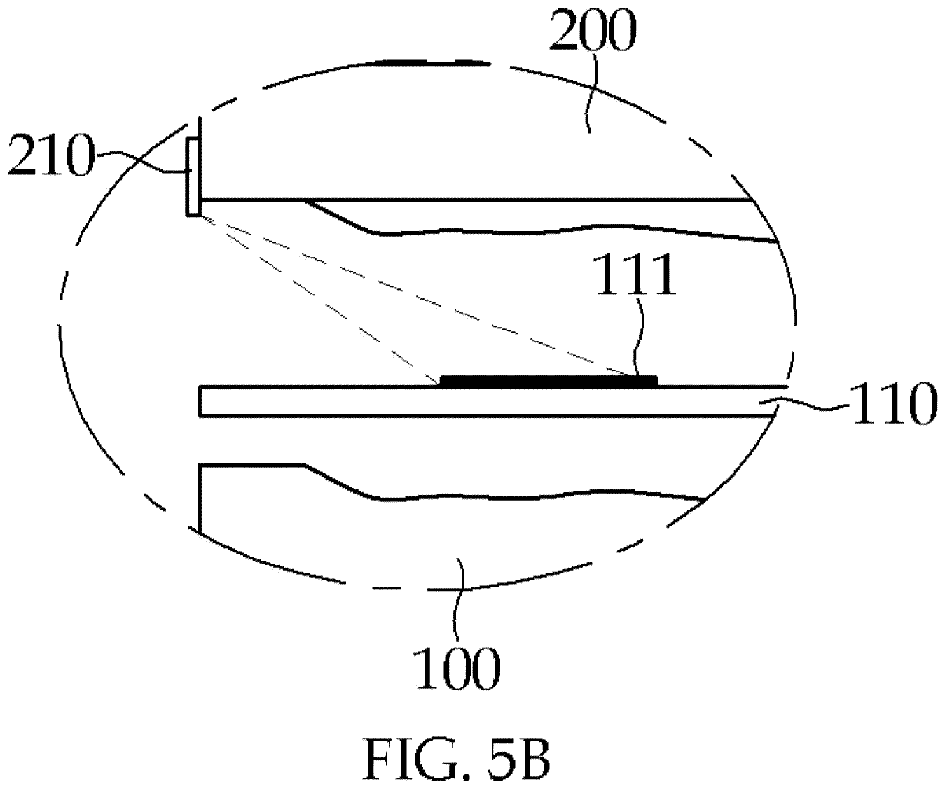

As illustrated in FIGS. 5A, 5B, 6, and 7, a forming mold according to the present invention includes a lower mold 100 on which a raw material 110 is disposed and an upper mold 200 which faces the lower mold 100 to be shape-coupled to and shape-separated from the lower mold 100.

In particular, as at least one laser pointer 210 is mounted on the upper mold 200, when an auxiliary raw material 111 is disposed on and integrally molded with the raw material 110 disposed on the lower mold 100, a position at which the auxiliary raw material 111 is disposed on the raw material 110 is marked, and the auxiliary raw material 111 is quickly accurately disposed at a predetermined position on the raw material 110 and integrally molded with the raw material 110.

In this case, as the laser pointer 210 is formed to indicate a position at which a vertex portion of the auxiliary raw material 111 is disposed, a vertex of the auxiliary raw material 111 is determined and easily accurately disposed at a point indicated by the laser pointer 210 so that the auxiliary raw material 111 is accurately molded and a defect rate is reduced.

In addition, as at least two laser pointers 210 are installed on a perimeter of an edge of the upper mold 200 to indicate vertex portions of the auxiliary raw material 111, the auxiliary raw material 111 is accurately positioned at a predetermined position.

Hereinafter, such a structure will be described in more detail with reference to the accompanying drawings.

A. Lower Mold

As illustrated in FIGS. 5A and 5B, the raw material 110 required for molding a molded product is disposed on the lower mold 100, and the lower mold 100 supports the raw material 110. As the upper mold 200, which will be described below, is shape-coupled to the lower mold 100, the raw material 110 is molded in a predetermined shape to produce the molded product.

Accordingly, as illustrated in FIG. 5 FIGS. 5A and 5B, a cavity in a spatial type is formed in a surface of the lower mold 100 facing the upper mold 200 to form a shape of the molded product. In addition, although the raw material 110 is formed into a complex three-dimensional shape after being molded, the raw material 110 which has a flat shape or is flexible like fabric is mainly used when the raw material 110 is disposed on the lower mold 100.

In addition, as illustrated in FIGS. 5A, 5B, 6, and 7, the auxiliary raw material 111 is disposed on the surface, which faces the upper mold 200, of the raw material 110 disposed on the upper mold 200. In this case, the auxiliary raw material 111 refers to a member disposed to partially overlap the surface of the raw material 110 and integrally molded to obtain secondary effects of reinforcing rigidity, improving noise performance, and the like.

As illustrated in FIG. 5, the lower mold 100 formed as described above is installed to face the upper mold 200.

B. Upper Mold

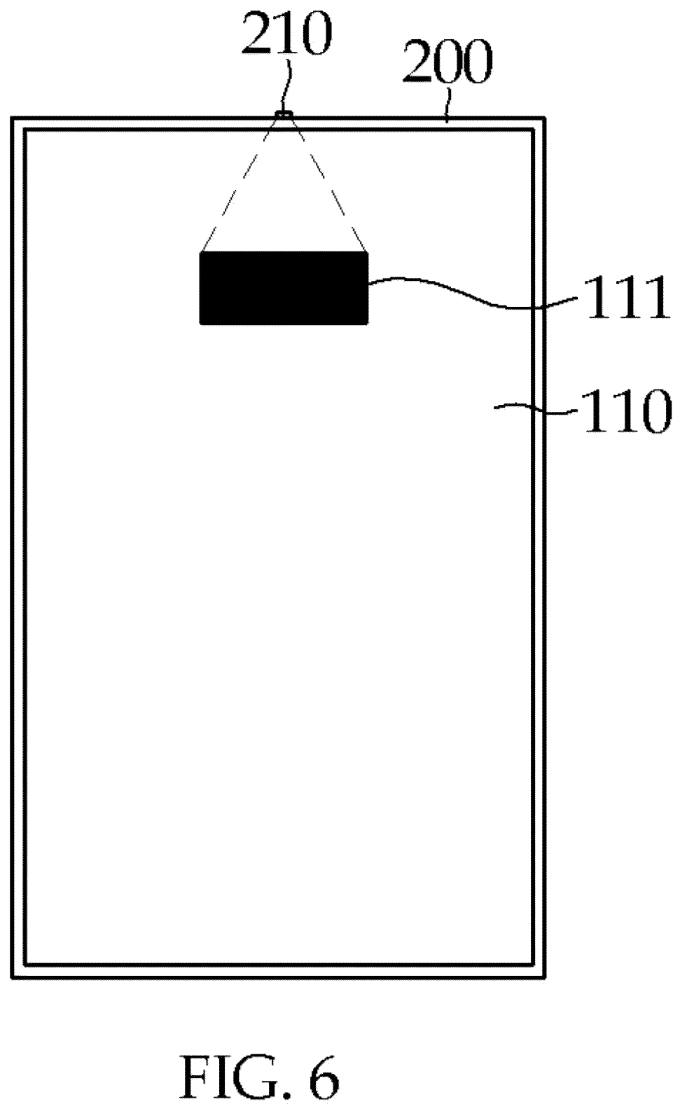

As illustrated in FIGS. 5A, 5B, and 6, the upper mold 200 is installed to face the lower mold 100 described above. In addition, on a surface of the upper mold 200 facing the lower mold 100, a cavity is formed in a shape of the molded product formed of the raw material 110.

In addition, as illustrated in FIGS. 5A, 5B, and 6, at least one laser pointer 210 is mounted on the upper mold 200. In this case, the laser pointer 210 is mounted at a position at which the laser pointer 210 is not interfered with when the lower mold 100 and the upper mold 200 are shape-coupled, and when the upper mold 200 is shape-separated from the lower mold 100, the laser pointer 210 may emit a laser beam onto a surface of the raw material 110 to indicate a stacking position of the auxiliary raw material 111 disposed on the raw material 110.

In the exemplary embodiment of the present invention, as illustrated in FIG. 6, as the laser pointers 210 are mounted on the upper mold 200 to emit laser beams at vertex positions of the auxiliary raw material 111 when emitting the laser beams onto the surface of the raw material 110, when the auxiliary raw material 111 is disposed on the raw material 110, at least two vertices of the auxiliary raw material 111 may be disposed at points indicated by the laser pointers 210 to quickly arrange the auxiliary raw material 111 at a predetermined position on the surface of the raw material 110 so that the auxiliary raw material 111 is molded.

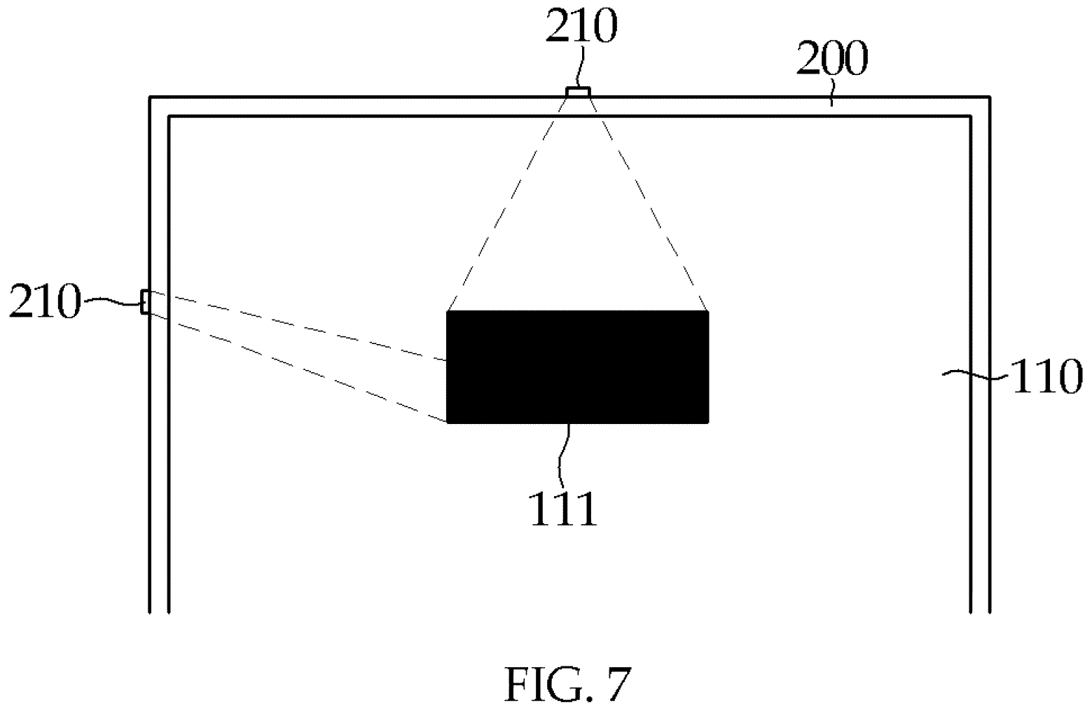

In addition, in an exemplary embodiment of the present invention, as illustrated in FIG. 7, as at least two laser pointers 210 are mounted on an edge portion of an upper mold 200, and the laser pointers 210 are formed to mark vertex positions of an auxiliary raw material 111, the auxiliary raw material 111 can be more accurately quickly disposed at a predetermined position on a surface of the raw material 110 so that the auxiliary raw material 111 is molded.

As described above, in the present invention, as the laser pointer is mounted on the upper mold and installed to indicate a position at which a vertex of the auxiliary raw material is disposed, the auxiliary raw material can be easily quickly accurately disposed and molded at a predetermined position on the surface of the raw material. In this case, as at least two laser pointers are installed to indicate vertex positions of the auxiliary raw material, the auxiliary raw material can be more easily accurately disposed at a desired position so that a molding process may be performed.

A forming mold according to the present invention has the following effects.

(1) As a position of an auxiliary raw material disposed on a raw material is accurately pointed using a laser pointer, everyone can easily accurately arrange the auxiliary raw material at a predetermined position on the raw material.

(2) Accordingly, when the raw material and the auxiliary raw material are integrally molded, the auxiliary raw material can be quickly disposed at the predetermined position, and thus a raw material molding efficiency can be improved.

(3) In addition, since the auxiliary raw material is accurately disposed at the predetermined position as described above, the auxiliary raw material can be prevented from deviating from the predetermined position to reduce a defect rate and improve productivity.

(4) Meanwhile, as the laser pointer is formed to mark a position according to a position at which vertexes of the auxiliary raw material are positioned on the raw material, everyone can use the vertexes of the auxiliary raw material to accurately arrange the auxiliary material at the predetermined position.

(5) In this case, as at least two laser pointers are installed on a perimeter of an upper mold and mounted at positions at which the laser points can mark vertices of the auxiliary raw material, the auxiliary raw material can be more accurately quickly disposed at the predetermined position and integrally molded.

What is claimed is:

1. A forming mold comprising:
a lower mold (100) on which a raw material (110) to be molded in a predetermined shape is disposed; and
an upper mold (200) installed to face the lower mold (100) and shape-coupled to and shape-separated from the lower mold (100),
wherein at least one laser pointer (210) is mounted on the upper mold (200), and
the laser pointer (210) marks a position of an auxiliary raw material (111) when the auxiliary raw material (111) is disposed on and integrally molded with the raw material (110).

2. The forming mold of claim 1, wherein the laser pointer (210) is mounted to mark at least two vertices of the auxiliary raw material (111).

3. The forming mold of claim 1, wherein the laser pointer (210) is provided as at least two laser pointers (210) installed along an edge of the upper mold (200) and marks vertices of the auxiliary raw material (111).

4. The forming mold of claim 2, wherein the laser pointer (210) is provided as at least two laser pointers (210) installed along an edge of the upper mold (200) and marks vertices of the auxiliary raw material (111).
